(19) United States
(12) Patent Application Publication
(10) Pub. No.: US 2014/0149498 A1
(43) Pub. Date: May 29, 2014

(54) METHOD AND ARCHITECTURE FOR LOCAL CONTENT SHARING USING DYNAMIC LOCATION MAPPING

(71) Applicant: TELEFONAKTIEBOLAGET L M ERICSSON (PUBL), Stockholm (SE)

(72) Inventors: Vishwamitra Nandlall, McKinney, TX (US); Haseeb Akhtar, Garland, TX (US); Suresh Narayanan, Plano, TX (US)

(73) Assignee: TELEFONAKTIEBOLAGET L M ERICSSON (PUBL), Stockholm (SE)

(21) Appl. No.: 13/685,314

(22) Filed: Nov. 26, 2012

(51) Int. Cl. H04L 29/06

(52) U.S. Cl. CPC H04L 65/403
USPC 709/204

(57) ABSTRACT

A user in a telecommunications network is able to share self-generated content to a list of friends dynamically created according to a location of each friend. The user checks with the network operator to determine whether friends from a list available to a Local Content Service (LCS) are nearby. The LCS utilizes a Location Management Server, Mapping Server and Media Server to manage the list of friends. Registered friends are determined to be in a predetermined radius of the user and the list of friends in the radius is provided to the user. The user selects the friends from the list and uploads the self-generated content to the LCS where a URI is assigned to the content and the URI is forwarded to the selected friends.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

Content sharing among friends and families is a very popular aspect of today's social networking applications. This trend is expected to continue as the users transfer their social networking applications to the mobile environment, including mobile phones, tablet or pad computers, etc. However, current applications do not allow sharing a user's personal content with a group of friends, in a secure and dynamic manner, even when the group of friends may be located in close proximity with the each other.

Existing mobile social networking applications have drawbacks and deficiencies; e.g., lists of friends are static and are not that easy to change and security for sharing content is not a top priority. Typically, credential management of users that are included in a possible content sharing application is not that important. At least these two areas need to change so that a user can share self generated content with other users, confident that the content is secure and this content sharing can provide a potential revenue source for a network operator.

The amount of data traffic in the current 4G and 3G networks has grown exponentially, especially given the mass adoption of smart phones and other mobile high bandwidth devices. Yet, the RF spectrum that can be used commercially is limited and in North America the utilization of available spectrum is already near 80%. There is therefore a clear need for additional capacity per MHz of spectrum available.

### SUMMARY

The present invention solves the problem of providing a secure platform for users to stream their own generated content, including music, videos, photos, etc. to anyone within a predetermined radius.

Content may be shared between a first mobile device and a plurality of devices in a communication network, where each of the plurality of devices are registered with a Local Content Sharing (LCS) service in the network. A user of the first mobile device generates a personal content such as a video and the first mobile device can send a query to a Location Management Server (LMS) associated with the communication network. The query is for determining if there are other mobile devices, associated with friends of the user, within a predetermined radius of the first mobile device. The LMS utilizes a Mapping Server associated with the LCS to determine a location of the first mobile device and the LMS accesses a friend contact list of the user to use in determining whether the friends are located within the predetermined radius; the LMS compiling a temporary list of the friends that are inside the predetermined radius. Next a temporary list of the user's friends is sent to the user for approval and the user selects friends from the temporary list. The user then uploads the generated content to storage associated with the LMS, wherein the LMS transmits an IP address and/or a URI (Uniform Resource Identifier) of the stored content to the selected friends.

An apparatus for sharing content between a first mobile device and a plurality of devices in a communication network, each of the plurality of devices being registered with a Local Content Sharing (LCS) service in the network, the apparatus comprising:

the first mobile device for generating a personal content; a Location Management Server (LMS) associated with the communication network, the LMS having a computer, comprising a processor, persistent memory with stored instructions, the memory coupled to the processor which executes the stored instructions causing the computer to: process a query from a user, received from the first mobile device, the query for determining if there are mobile devices, associated with friends of the user, within a predetermined radius of the first mobile device; determine a location of the first mobile device from a Mapping Server using the LCS; access a friend contact list of the user and determine whether the friends and the associated mobile devices are located within the predetermined radius; and compile a temporary list of the friends that are in the predetermined radius and send the list to the user for approval; and receive the generated personal content for storing; and send an IP address and/or URI linked to the stored, generated personal content to the friends mobile devices.

### BRIEF DESCRIPTION OF THE SEVERAL VIEWS OF THE DRAWINGS

The novel features believed characteristic of the invention are set forth in the appended claims. The invention will best be understood by reference to the following detailed description of an illustrative embodiment when read in conjunction with the accompanying drawings, wherein:

FIG. 1 is a high level block diagram of the architecture in which an embodiment of the present invention may be implemented in accordance with an embodiment of the present invention;

FIG. 2, depicts high level flows of Local Content sharing according to an embodiment of the present invention;

FIG. 3, illustrates a high level flow diagram for a process according to an embodiment of the present invention;

FIG. 4 depicts a high level block diagram of a Location Management Server according to an embodiment of the present invention; and

FIG. 5 is a diagram of Local Content Sharing for WiFi users according to an embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

The functionality can be implemented by means of hardware comprising several distinct elements and by means of a suitably programmed processing apparatus. Hardware is indicated in the drawings with high level block diagrams as a person skilled in the art is aware that the entities illustrated by the block diagrams require the processing apparatus in order to execute instructions to perform certain operations. The processing apparatus can comprise a computer, a microprocessor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

Throughout the remainder, the following abbreviations will be used in describing and disclosing the present invention:

### ABBREVIATIONS

ASIC Application Specific Integrated Circuit

DSP Digital Signal Processor

EEPROM Electrically Erasable Programmable ROM

EPROM Electrically Programmable ROM

FPGA Field Programmable Gate Array

HTTP Hyper Text Transfer Protocol

LDAP Lightweight Directory Access Protocol

MDS Media Server

MS Mapping Server

OTT Over The Top

PCRF Policy and Charging Rules Function

QoS Quality of Service

RAM Random Access Memory

RAN Radio Access Network

RAT Radio Access Technology

Rest REpresentational State Transfer

Rn Radio node

ROM Read Only Memory

UE User Equipment

URI Uniform Resource Identifier

WAC Wholesale Application Community

WIMAX Worldwide Interoperability for Microwave Access

WLAN Wireless Local Area Network

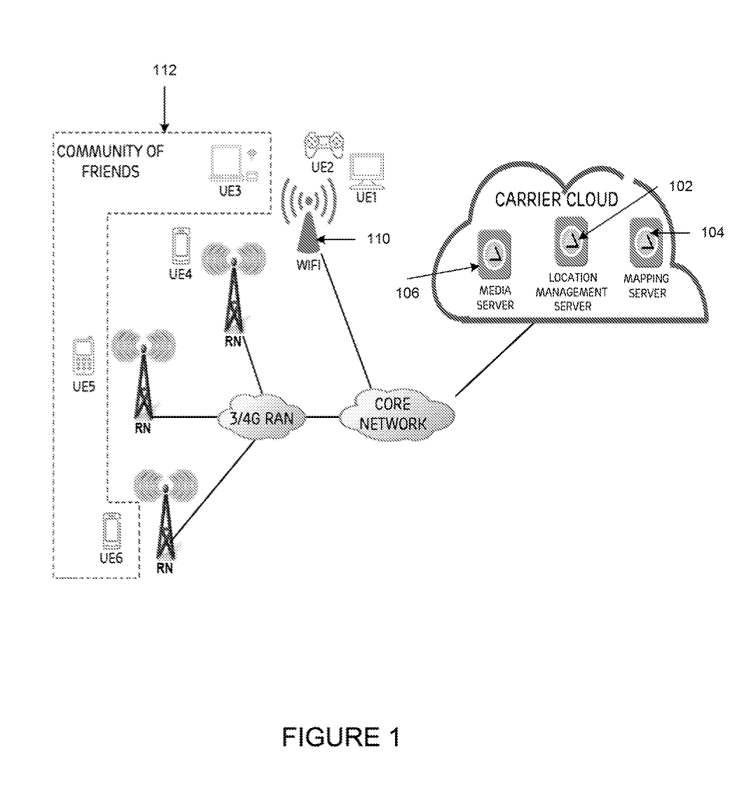

With reference to the figures and in particular with reference to FIG. 1, a high level block diagram of the architecture in which an embodiment of the present invention may be implemented is depicted (LMS) 102 performs credential validation of all subscribers. Location information of the user's Community of Friends is updated during a location content sharing session. LMS 102 supports an Rx interface to PCRF (Policy and Charging rules Function) in order to push policy and/or QoS (Quality of Service) to the operator's network; supports HTTP, Rest (REpresentational State Transfer) and/or LDAP interfaces to the Mapping Server and supports HTTP and Rest interfaces to Media server (MdS) 106.

Mapping Server (MS) 104 stores latitude and longitude coordinates of 3G and 4G cell sites, WLAN hot spots, homes, enterprises, etc. MS 104 also provides the capability to look up 3G and 4G cell sites, WLAN hotspots, enterprises, etc., within a geographical boundary (e.g., 1000 feet) of a given or determined location (latitude and longitude). MS 104 also supports HTTP, Rest and/or LDAP interfaces to LMS 102.

Media Server (MDS) 106 stores and distributes user generated content and performs reformatting so as to meet device and/or bandwidth specific requirements of devices that are to receive the generated content. MDS 106 further supports HTTP and Rest interfaces to LMS 102.

Further, connections of the various types of User Equipment (smartphones, computers, game systems, televisions, etc.) are illustrated with the connections being provided through both 3G and 4G RAN 108, WiFi 110, wireline access connections and WLAN access points. UE3, UE5, and UE6 that are enclosed in the dotted area are ‘friends’ and are presently considered as being in a ‘Community of Friends’ 112.

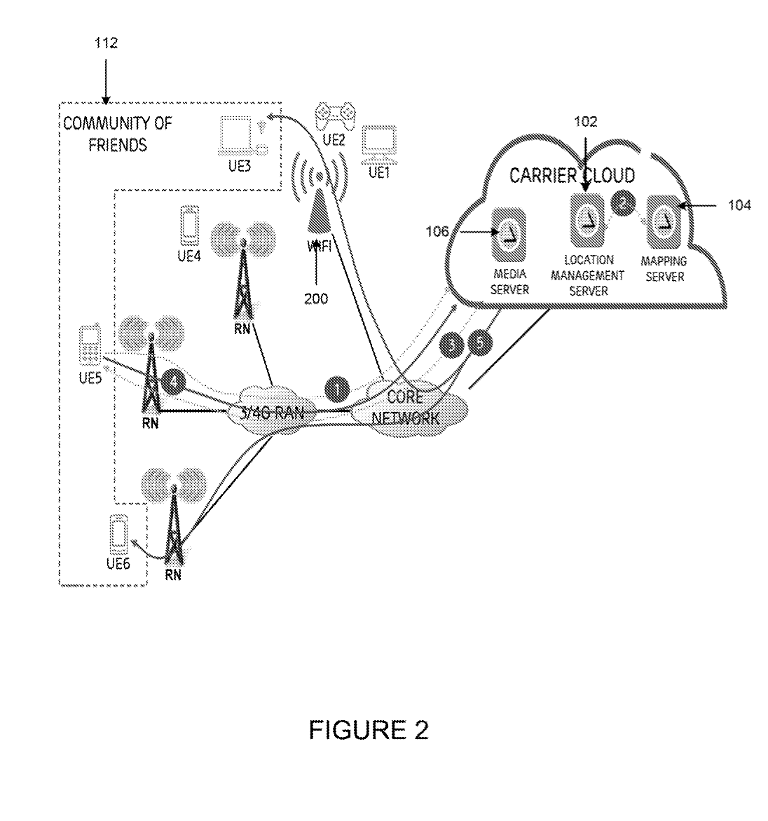

FIG. 2, depicts high level flows of Local Content sharing according to an embodiment of the present invention. All the User Equipments (UE) depicted in FIG. 2 subscribe to a Local Content Sharing (LCS) Service from the network operator. Components of the LCS include LMS 102, MS 104 and MDS 106. In this embodiment, the user of UE5 generates personal content (video, photographs, etc.) and sends a query (1) to the operator to check if any of the UE5's friends are in the area. Along with the query, UE5 sends its GPS information to the operator (1). (single numbers in parentheses are indicated in FIG. 2 as signal flows).

In response to the query, the operator validates UE5's credentials via LMS 102. The Operator uses LMS 102 and Mapping Server (MS) 104 to identify UE5s LCS registered ‘friends’ that are located within a predefined radius (e.g., 1000 feet) from UE5 (2). In this instance both UE3 (connected to the WLAN network) and UE6 (connected to 3/4G RAN) satisfy the criteria.

The Operator informs UE5 (3) that UE3 and UE6 are in UE5's ‘Community of Friends’ 112 and are available within the predefined radius, whereupon UE5 uploads the generated personal content to the Operator's MDS 106 (4). The content is then stored by the Operator in storage associated with MDS 106.

The credentials of both UE3 and UE6 are validated by LMS 102. After validation, MDS 106 transmits the previously stored UE5 content to UE3 and UE6 (5). Transmitting the content directly to the LCS members is reasonable when there is one or two members. However, when the members that are within the radius are fairly numerous, the Operator sends a link (e.g., IP address, URI etc.) to the stored content so that the notified members may access the stored content.

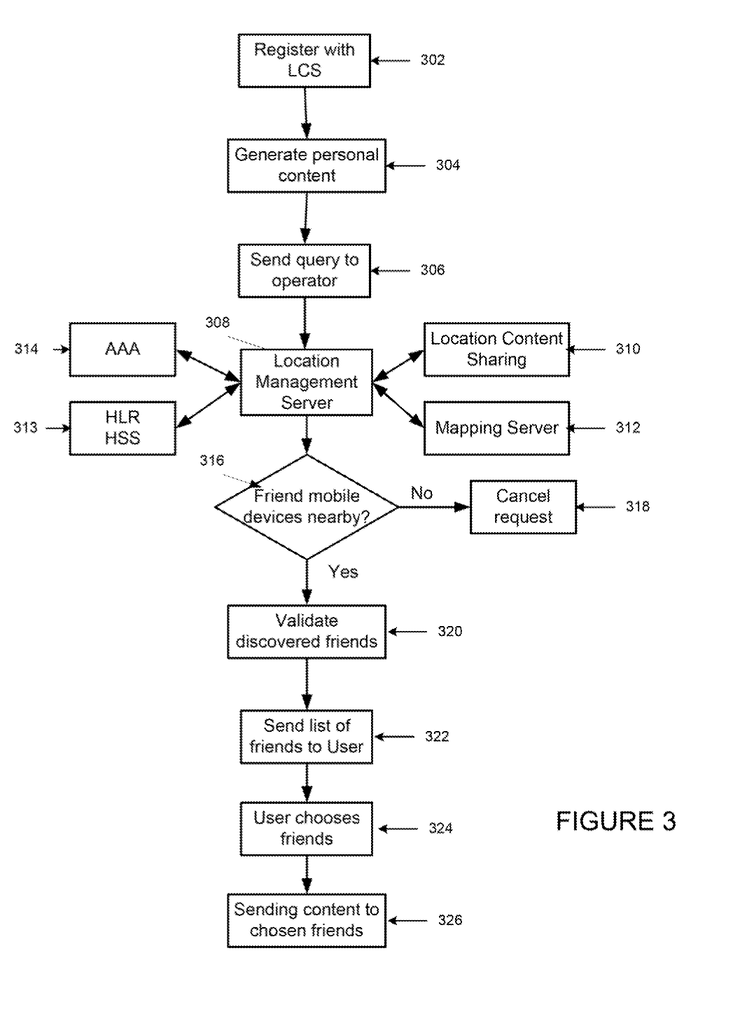

FIG. 3, illustrates a high level flow diagram for a process according to an embodiment of the present invention. The process begins with users registering with a Location Content Service (step 302) from which a Community of Friends for a particular user is compiled from the registered users that designate the user as a friend. This list may be compiled when all the friends, including the inquiring user, are registered at the Location Content. Service (LCS). Alternatively, the list may be compiled from a list of friends that are stored on an inquiring user's user equipment. The list of friends may be accessed by the LMS (with permission of the registered user) when the inquiring user makes the initial query. Even a combination of the inquiring user's Community of Friends already uploaded at the LCS upon registration and the list stored on the user equipment can be used to compile a current list of friends. The registered users may consist of friends that are known to each other and in some instances may be known only to the inquiring user, but not known to each other.

The process moves to step 304 which depicts a user generating personal content, such as video, photos, text, etc., on the inquiring user's User Equipment. The user, in order to provide the generated personal content to friends, queries the operator to determine if there are mobile devices nearby that are associated with the user's Community of Friends (step 306).

After receipt of the query from the inquiring user, the operator determines the physical location of the inquiring user by accessing the Location Management Server (LMS). The LMS utilizes the Location Engine (step 314) and Mapping Server (MS) to locate and map the locations of the inquiring user's Community of Friends (users registered in the LCS) to determine if any of the inquiring user's friends are within a predetermined radius of the inquiring user (step 308). The LMS determines the user's location and searches within a predetermined radius of the location of the inquiring user to find any of the community of friends (step 316). If there are none, the request is canceled (step 310)

If the operator determines that there are friends within the predetermined radius of the location of the inquiring user, the Location Management server is notified of the specific user (friend) devices that were found in that radius. The LMS accesses the MA server (step 315) and the Home Location Register/Home Subscriber Server (HLR/HSS) (step 317) to validate and authenticate the discovered user devices (step 318).

Next, the LMS sends a list of the mapped and validated friend devices that are located within the specified radius and a check off list that allows the inquiring user to pick which friend devices to send the submitted personal content (step 322). The inquiring user then uploads the generated personal content to storage associated with the Media Server (MDS) and a URI is assigned to the content (324).

The LMS then causes the MDS to transmit a URI associated with the stored personal content to the devices selected by the inquiring user, where the selected devices may be smart phones, Ipad PDA, WiFi connected laptops, etc. The friends may then access the uploaded personal content.

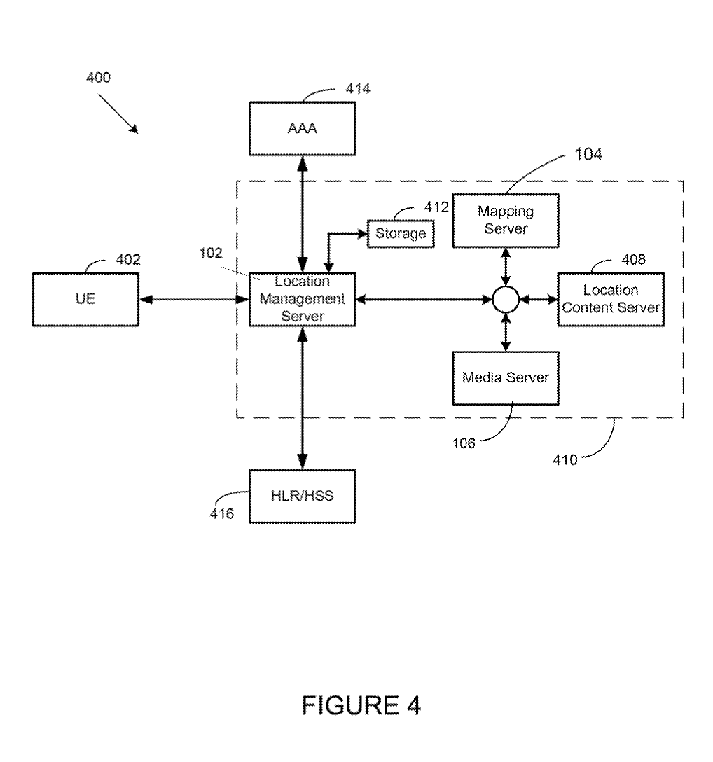

FIG. 4 depicts a high level block diagram of a Location Management Server (LMS) apparatus and associated devices, according to an embodiment of the present invention. LMS 102, Location Content Server (LCS) 408, Mapping Server (MS) 104 and Media. Server 106 are located, network wise, in a carrier's cloud. Together, the devices provide Location Content Service 410. LMS 102 provides credential validation of all the subscribers through the use of AAA 414 and HLR/HSS 416. LMS 102 updates location information for registered users of the Location Content service regularly via location update information received from the 3G, 4G and WiFi RATs (Radio Access Technology).

UE 402 is in communication with LMS 102 and may send a query for providing a list of friends with a predetermined area. The list of friends may be compiled from a pre-loaded UE 402 contact list in storage at LCS 408. The list may also be compiled from a list of friends that are stored in memory in UE 402. The list of friends may be accessed by the LMS 102 (with permission of UE 402) when the inquiring user makes the initial query. Even a combination of the inquiring user's contact list already uploaded at the LCS upon registration and the list stored on the user equipment can be used to compile a current list of friends.

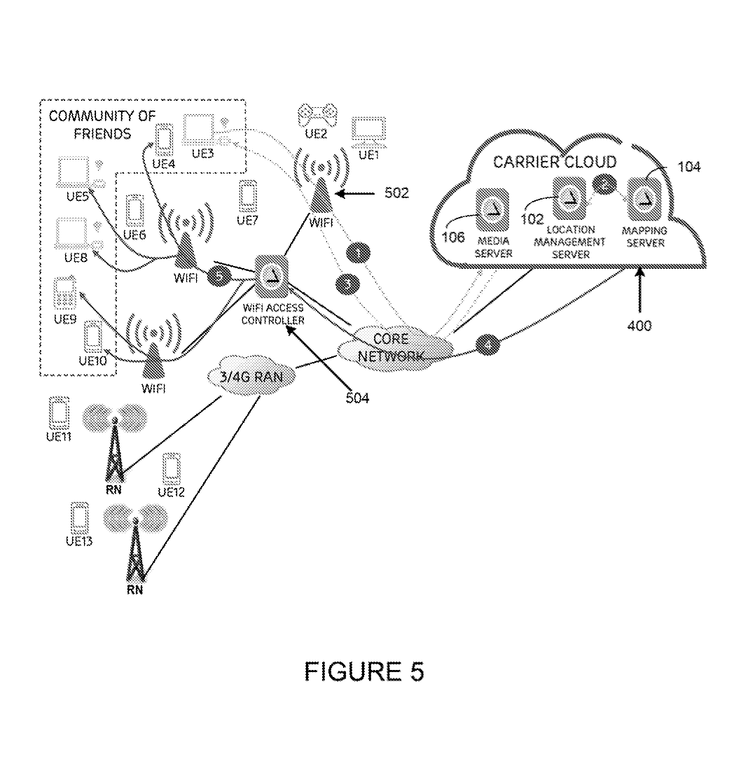

FIG. 5 is a diagram of a Local Content. Sharing server for WiFi users according to an embodiment of the present invention. All UEs shown subscribe to a Local Content Sharing (LCS) service provided by the operator of the network. In this embodiment UE3 generates a personal content and queries the operator (1), via WiFi if any of the UE3's friends are in the Area.

The Operator validates, e.g., UE3's credentials via LMS 102. The Operator then uses LMS 102 and MS 104 to identify UE3's friends that are located within a predetermined radius (e.g., 1000 to 3000 feet) of UE3 (2). As it happens, UE4, UE5, UE8, UE 9 and UE 10 are within the radius and connected to the Operator's network via WiFi Access Controller (WAC) 504 and they all satisfy these criteria. The credentials of all the friends of UE3 are also validated.

The Operator informs UE3 that UE4, UE5, UE8, UE 9 and UE 10, from UE3's Community of Friends, are available within the specified radius (3). UE3 then uploads the personal content to the Operators Media Server (104) where it is stored. Then the LCS (depicted in the carrier cloud) transmits a URI, which links to each of the members of UE3's Community of Friends via WAC 504, the previously stored content from UE3 to UE4, UE5, UE8, UE 9 and UE 10.

Extending the use case, any of the UEs within the ‘Community of Friends’ can share content with other UEs. Media that can be shared may include audio, video and file sharing as well as web meeting, interactive ‘white board’ sessions, web based real time communications, etc.

The present invention allows users to share content with friends in a list that is created dynamically based on the proximity of the friends' devices and the friends' device capabilities, connection states, etc. Operators (carriers) can monetize their assets by providing a service that cannot be offered by Over the Top (OTT) providers. OTT providers cannot use a user's current location to provide a Community of Friends that is based on location information obtained from 3G/4G RAN, WiFi at home and WiFi at a business, etc., all while taking into account the connection state, devices' capability, validation of the devices, etc. This advantage enables a carrier to offer a secured content sharing service within a user's community of Friends within a close proximity (e.g., 1000 to 3000 feet radius).

Operators that also provide WLAN services (e.g., Hotspot, Hotzone, etc.) can provide this feature at venue events such as ball games, conferences, social/business meetings, and so on, where the users are more apt to share local content. For a venue event, operators may monetize the network without adding spectrum cost since WiFi uses non-licensed RF resources. Users of the Local Content Service are able to stream their own music, videos, and photos from the users' phones to anyone within a predetermined radius.

In one or more exemplary embodiments, the functions described may be implemented in hardware, software, firmware, or any combination thereof. If implemented in software, the functions may be stored on or transmitted over as one or more instructions or code on a computer-readable medium, Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof, designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method of sharing content between a user's mobile device and a plurality of devices in a communication network, each of the plurality of devices being registered with a Local Content Sharing (LCS) service in the network, the method comprising:
the user of the mobile device generating a personal content;
the user's mobile device sending, a query to a Location Management Server (LMS) associated with the communication network, the query for determining if there are mobile devices, associated with friends of the user, within a predetermined radius of the user's mobile device;
the LMS utilizing a Mapping Server with the LCS to determine a location of the user's mobile device;
the LMS accessing a friend contact list of the user and determining whether there are friends in the contact list located within the predetermined radius;
the LMS compiling a temporary list of the friends that are located in the predetermined radius and sending the temporary list to the user for approval; and
the user selecting friends from the temporary list and uploading the generated personal content to storage associated with the LMS, wherein the LMS transmits an IP address or URI (Uniform Resource Identifier) of the stored personal content to the selected friends.

2. The method of claim 1, the LMS transmitting the IP address and URI of the stored personal content to the selected friends.

3. The method of claim 1, the temporary friend list for the user is compiled from a contact list of the user stored in a memory associated with the LCS.

4. The method of claim 1, wherein the LMS accesses a contact list stored in the user's mobile device to compile the temporary friend list.

5. An apparatus for sharing content between a user's mobile device and a plurality of devices in a communication network, each of the plurality of devices being registered with a Local Content Sharing (LCS) service in the network, the apparatus comprising:
the user's mobile device for generating a personal content;
a Location Management Server (LMS) associated with the communication network, the LMS having
a computer, comprising a processor, persistent memory with stored instructions, the memory coupled to the processor which executes the stored instructions causing the computer to:
process a query from the user's mobile device, the query for determining if there are mobile devices, associated with friends of the user, within a predetermined radius of the user's mobile device;
determine a location of the user's mobile device from a Mapping Server using the LCS;
access a friend contact list of the user and determine whether the friends' associated mobile devices are located within the predetermined radius;
compile a temporary list of the friends that are in the predetermined radius and send the list to the user's mobile device for approval;
receive the generated personal content for storing; and
send an IP address or URI (Uniform Resource Identifier) linked to the stored, generated personal content to the friends' mobile devices.

6. The apparatus of claim 5, further comprising:
the processor causing the temporary list to be sent to the user's mobile device, where upon receipt of the temporary list, the user choosing from the temporary list, which of the friends' mobile devices to send the generated content to; and
the user's mobile device uploading the generated personal content to storage associated with the LMS

7. The apparatus of claim 5, wherein the computer causes the LMS to transmit an IP address and URI of the stored content to devices associated with the selected friends.

8. A Location Management Server (LMS) associated with the communication network, the LMS comprising:
a computer, having a processor and persistent memory with stored instructions, the memory coupled to the processor which executes the stored instructions causing the computer to:
process a query received from a user's mobile device, the query for determining if there are mobile devices, associated with friends of the user, within a predetermined radius of the user's mobile device;
determine a location of the user's mobile device from a Mapping Server using the LCS;
access a friend contact list of the user and determine whether the friends and the associated mobile devices are located within the predetermined radius;
compile a temporary list of the friends that are in the predetermined radius and send the list to the user for approval;
receive the generated personal content from the user's device for storing in storage associated with the LMS; and
send an IP address or URI (Uniform Resource Identifier) linked to the stored, generated personal content to the friends' mobile devices.

9. The LMS of claim 8 wherein the friend contact list is stored in memory associated with a Location Content Server (LCS) the LCS being connected to the LMS.

10. The LMS of claim 8, wherein the computer in the LMS accesses a friend contact list of the user in the users mobile device.

11. The LMS of claim 8, wherein the computer in the LMS sends an IP address and URI linked to the stored, generated personal content to the mobile devices linked to the friends list.
